(19) United States
(12) Patent Application Publication
(10) Pub. No.: US 2008/0003914 A1
(43) Pub. Date: Jan. 3, 2008

(54) NON-WOVENS INCORPORATING AVIAN BY-PRODUCTS

(76) Inventors: Marc Privitera, (US); David Jackson Lestage, (US); Gregory van Buskirk, (US); Bernard Hill, (US); Nikhil Dani, (US)

Correspondence Address: THE CLOROX COMPANY, P.O. BOX 24305, OAKLAND, CA, 94623-1305, US

(21) Appl. No.: 11/427,697

(22) Filed: Jun. 29, 2006

(51) Int. Cl. D04H 1/00; D04H 1/54; B32B 5/16

(52) U.S. Cl. 442/417; 442/361; 442/409; 442/411

(57) ABSTRACT

The present invention relates to a non-woven web comprising fibers and feathers for use as a substrate for cleaning articles. The non-woven web may be created using a variety of non-woven processing techniques and bonding treatments to bond the fibers. The non-woven web is made by combination of variety of fiber types and feathers in varying proportions which create non-woven webs with varying levels of loft, weight, tensile strength, absorbency and abrasiveness.

### BACKGROUND OF THE INVENTION

1. Field of the Invention

The present invention relates generally to the field of non-woven composites. More specifically, the present invention relates to non-woven composites for use in cleaning applications.

2. Description of the Related Art

A composite is made from two or more constituent materials. Non-woven composites are composites wherein the two or more constituent materials are neither woven nor knit. Non-woven composites are manufactured by depositing fibers to form a sheet and binding the fibers in the sheet by a variety of different methods including, but not limited to mechanical bonding, thermal bonding, chemical bonding, and combinations thereof. Non-woven composites may comprise natural fibers, synthetic fibers, continuous fibers, staple fibers, bi-component and multi-component fibers. Examples of natural fibers include, but are not limited to, wood pulp, cotton, linen, seed fiber, stalk fiber, leaf fiber, bast fiber, fruit fiber, cellulose, and the like. Examples of natural animal fiber include, but are not limited to, silk fiber, animal hair and bird feathers or fibers.

Disposal of agricultural waste such as bird feathers is increasingly becoming a cause of concern as consumption levels are rising around the world. Use of such waste material in commercial articles is attracting much research and development. Bird feathers are used in making a variety of articles such as, sleeping bags, pillows and mattresses because they add bulk, fluff and softness while keeping the weight of the article low. Bird feathers are also used for thermal insulation applications such as bedding, clothing and other insulating materials.

European patent publication EP0599396A1 discloses a method for producing a non-woven composite using feathers and melt-blown fibers. The non-woven composites disclosed are used for thermal insulation applications. US patent publications U.S. Pat. No. 6,232,249B1, US20020/007900 and US2004/0175532 also disclose use of a fiber-feather non-woven composite for thermal insulation applications.

US patent publication U.S. Pat. No. 6,025,041A discloses a down feather sheet for use in thermal insulation applications. The down feather sheet comprises down feathers spread on a support surface. The down feathers are retained together in a sheet form using a chemical binder.

US patent publication U.S. Pat. No. 6,589,892 discloses a non-woven composite comprising bi-component fibers and an absorbent material such as bird feathers. The non-woven composite is used as an absorbent. The non-woven composite is manufactured using melt-blown and spun-bond techniques.

In light of the foregoing discussion, there exists a need for additional uses for waste materials, such as bird feathers, in applications other than thermal insulation and absorbent materials. In addition, there is a need to develop cost efficient articles for cleaning with high-loft, low weight, and desirable abrasive properties for use in cleaning applications. Additionally, the article should comprise agricultural waste such as bird feathers in order to find an effective solution to the problem of disposal of the agricultural waste. Further, there exists a need for fiber-feather non-woven composites with high tensile strength

### SUMMARY OF THE INVENTION

One embodiment of the present invention provides a non-woven web for use in cleaning applications.

Another embodiment of the present invention provides an abrasive non-woven web that provides a mild scrubbing action on an article being cleaned.

Another embodiment of the present invention provides for an article for cleaning a surface, which has good tensile strength, low basis weight and comprises a waste material.

In accordance with the above embodiments and those that will be mentioned and will become apparent below, one aspect of the present invention comprises a non-woven web for cleaning articles. The non-woven web comprises bi-component fibers and feathers. The amount of the bi-component fibers in the non-woven web ranges from about 10% to 99% by weight of the non-woven web and preferably from about 40% to 99% by weight, and more preferably from about 40% to 70% by weight. The amount of the feathers range from about 1% to 90% by weight of the non-woven web, preferably from about 1% to 60% by weight, and more preferably from about 30% to 60% by weight. The non-woven web has a mean breaking load greater than 0.9 lbf when in dry condition, and more preferably greater than 1.0 lbf.

In accordance with the above embodiments and those that will be mentioned and will become apparent below, another aspect of the present invention comprises a non-woven web comprising thermoplastic fibers and feathers. The non-woven web is made by airlaying the thermoplastic fibers and feathers.

In accordance with the above embodiments and those that will be mentioned and will become apparent below, another aspect of the present invention comprises a non-woven web comprising bi-component fibers and feathers. The non-woven web is made by airlaying the bi-component fibers and feathers. The bi-component fibers are selected from the group consisting of polypropylene, polyethylene, polyethylvinyl acetate, polyester, copolyester, polyethylene terephthalate (PET), and combinations thereof. Additionally, amount of the bi-component fibers in the non-woven web ranges from about 40% to 99% by weight of the non-woven web and amount of the feathers range from about 1% to 60% by weight of the non-woven web. Further, the percent elongation of the non-woven web in machine direction at breaking load is less than 15%, and preferably less than 10%, when the non-woven web is dry.

Further features and advantages of the present invention will become apparent to those of ordinary skill in the art in view of the detailed description of preferred embodiments below, when considered together with the attached claims.

### DETAILED DESCRIPTION OF THE INVENTION

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

As used herein and in the claims, the term “comprising” is inclusive or open-ended and does not exclude additional unrecited elements, compositional components, or method steps. Accordingly, the term “comprising” encompasses the more restrictive terms “consisting essentially of” and “consisting of”.

It must be noted that, as used in this specification and the appended claims, the singular forms “a,” “an” and “the” include plural referents unless the content clearly dictates otherwise. Thus, for example, reference to a “surfactant” includes two or more such surfactants.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, some of the preferred materials and methods are described herein.

Various embodiments of the present invention described herein provide a non-woven composite comprising feathers and fibers. In an embodiment of the invention, the non-woven composite can be used as a cleaning substrate. Cleaning substrate includes any material that can be used to clean an article or a surface. Materials that can be used as the cleaning substrate should have certain desirable properties such as abrasiveness and high tensile strength. A “non-woven web” is an example of one such cleaning substrate that can be used in cleaning implements, including but not limited to, wipes, scrubs, mops, swabs, towels, napkins, hand held cleaning tools, toilet cleaning devices, tub and shower cleaning tools and the like.

Unlike in a woven or a knitted web, the non-woven web refers to a random interlaid structure. Non-wovens also differ from composite structures, which have a structure that is made up of distinct components that are not necessarily integrated to form one structure. The non-woven web, as used herein, comprises a random interlaid structure of fibers and feathers wherein at least one layer of the non-woven web has a substantially uniform distribution fibers and feathers. Various fiber laying processes exist for forming the non-woven webs. Such processes include, but are not limited to, meltblowing, spunbonding, spunbonding-meltblowning-spunbonding (SMS), carding, wetlaying, airlaying, through-air-bonding (TAB) and hydroentangling.

As discussed herein, the fibers include staple fibers, non-continuous fibers, continuous fibers, and combinations thereof. Length of the staple fibers varies from 2 mm to 20 mm. Length of the non-continuous fibers is longer than 20 mm. The fibers used in the non-woven webs comprise natural fibers, synthetic fibers, and combinations thereof.

Natural fibers can comprise components, including but not limited to, cotton fibers, esparto grass fibers, bagasse fibers, hemp fibers, flax fibers, silk fibers, wool fibers, wood pulp fibers, chemically modified wood pulp fibers, jute fibers, ethyl cellulose fibers, cellulose acetate fibers and various pulp fibers. Pulp fibers comprise, but are not limited to, thermomechanical pulp fibers, chemi-thermomechanical pulp fibers, chemi-mechanical pulp fibers, refiner mechanical pulp fibers, stone groundwood pulp fibers, peroxide mechanical pulp fibers and the like. Natural fibers may be used in modified or unmodified form.

A synthetic fiber may comprise components such as polyvinyl chloride, polyvinyl fluoride, polytetrafluoroethylene, polyvinylidene chloride, polyacrylics such as ORLON®, polyvinyl acetate, Rayon®, polyethylvinyl acetate, non-soluble or soluble polyvinyl alcohol, polyolefins, polyamides, polyesters, polyurethanes, polystyrenes, polycarbonates, polyethylene terephathalate, biodegradable polymers such as polylactic acid and copolymers and blends thereof. Examples of polyacrylics include ORLON® and the like. Examples of polyolefins include polyethylene, polypropylene, polybutylene and polypentene. Examples of polyethylene include PULPEX®, high density polyethylene, medium density polyethylene, low density polyethylene, linear low density polyethylene and copolymers and blends thereof. Examples of polypropylene include isotactic polypropylene, syndiotactic polypropylene, blends of isotactic polypropylene and atactic polypropylene, and copolymers and blends thereof. Examples of polybutylene include poly(1-butene), poly(2-butene) and copolymers and blends thereof. Examples of polypentene include poly(1-pentene), poly(2-pentene), poly(3-methyl-1-pentene), poly(4-methyl 1-pentene) and copolymers and blends thereof. The copolymers include random and block copolymers prepared from two or more different unsaturated olefin monomers, such as ethylene/propylene and ethylene/butylene copolymers. Examples of polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Examples of polyesters include DACRON® or KODEL®, polyethylene terephthalate, polytrimethylene terephthalate, polybutylene terephthalate, polytetramethylene terephthalate, polycyclohexylene-1,4-dimethylene terephthalate, and isophthalate copolymers thereof, as well as blends thereof.

A fiber comprising at least two components is known as a “conjugate fiber” or a “multicomponent fiber”. The multicomponent fiber comprising two components is known as a “bi-component fiber”. The two components of the bi-component fiber are usually different from each other with respect to at least one physical property, such as, melting point, tensile strength, elasticity, and the like. The two components of the bi-component fiber are usually configured in a particular arrangement across the cross section of the bi-component fiber. The arrangement can be a sheath/core arrangement, a side-by-side arrangement or an islands-in-the-sea arrangement.

It is desirable that the components of the multicomponent fiber have melting points different from one another. Difference in melting points is important when through-air bonding is used as the bonding technique, wherein the lower melting point component melts and bonds the fibers together to form the non-woven web. It is desirable that the lower melting point component makes up at least a portion of the outer region of the multicomponent fibers. More particularly, the lower melting point component is preferably located in an outer portion of the multicomponent fiber so that it comes in contact with other fibers. For example, in the sheath/core arrangement, the lower melting point component is located in the sheath portion. In the side-by-side configuration, the lower melting point component is located on an outer portion of the multicomponent fiber.

Proportion of higher melting point component and the lower melting point component in the multicomponent fiber can range from 10% to 90% by weight of the higher melting point component and from 10% to 90% by weight of the lower melting point component. In practice, the amount of lower melting point component required is just sufficient to facilitate bonding between the fibers. Thus, a suitable multicomponent fiber composition may contain between 40% to 80% by weight of the higher melting point component and between 20% to 60% by weight of the lower melting point component, desirably ranging from 50% to 75% by weight of the higher melting point component and ranging from 25% to 50% by weight of the lower melting point component. In one embodiment, the lower melting point component is polyethylene and the higher melting point component is polypropylene.

Examples of polymers that can form the sheath portion of the sheath-core arrangement include polyethylene, polyethylvinyl acetate, polypropylene, copolyster and the like. Examples of polymers that can form core portion of the sheath-core arrangement include polypropylene, polyester and the like. Bi-component fibers in the sheath/core arrangement can have the following polymer combinations: polyethylene/polypropylene, polyethylvinyl acetate/polypropylene, polyethylene/polyester, polypropylene/polyester, copolyester/polyester, and the like. In a preferred embodiment, a bi-component sheath/core fiber consists of a core portion of polypropylene or polyester, and a sheath portion of a lower melting copolyester, polyethylvinyl acetate or polyethylene. Examples of the preferred bi-component sheath/core fibers include those available from Danaklon a/s, Chisso Corp. and Hercules. CELBOND® is an example of one such bi-component sheath/core fiber product, available from Hercules. The bi-component sheath/core fibers can be concentric or eccentric. As used herein, the terms “concentric” and “eccentric” refer to whether the sheath has a thickness that is even or uneven through the cross-sectional area of the bi-component sheath/core fiber. Eccentric bi-component fibers can be desirable in providing more compressive strength at lower fiber thicknesses.

“Basis weight” of the non-woven web is expressed in grams of non-woven material per square meter (gsm). Fiber diameter of the fibers incorporated in the non-woven web is expressed in microns. The fiber diameter is expressed in “denier” for staple fibers. Denier is a unit for measuring fiber fineness and is equal to mass in grams of 9000 meters of the fiber. For a fiber with circular cross-section, denier can be calculated as fiber diameter in microns squared, multiplied by the density in grams/cc, multiplied by 0.00707. A lower denier indicates a finer fiber and a higher denier indicates a thicker or heavier fiber. “Tex” is another unit for measuring the fineness of fibers. Tex is defined as grams per kilometer of fiber. Tex may be calculated as fiber fineness in denier divided by 9.

As used herein, “feathers” comprise bird feathers including but not limited to, chicken feathers, goose feathers, turkey feathers and duck feathers. The term “feathers” also includes bird feathers in their natural state or into a modified fibrous form. The bird feathers may be used as a bulk replacement for expensive polyolefin fibers that are normally used to make the non-woven webs. The bird feathers also provide a mild scrubbing action on the surface to be cleaned.

The “meltblowing process”, as discussed herein, refers to a process for producing non-woven fibrous webs from thermoplastic materials. Meltblown fibers are fibers formed by extruding a molten thermoplastic material through a plurality of fine die capillaries. The molten thermoplastic material coming out of the fine die capillaries is impacted by a high velocity gas stream. The gas stream can be a hot air stream. As a result of the impact of the high velocity gas stream, the thermoplastic material attenuates into fibers with micron size diameter. The fibers are then carried by the gas stream to a collecting surface to form the non-woven fibrous web of randomly dispersed fibers.

The “spunbonding process”, as discussed herein, refers to a process for producing non-woven fibrous webs by extruding molten thermoplastic material through a plurality of fine capillaries of a spinneret. The extruded molten thermoplastic material is deposited on a collecting surface as continuous fibers. The continuous fibers have average diameters (from a sample of at least 10 fibers) larger than 7 microns, preferably between 7 microns to 60 microns, and more preferably between 15 microns and 25 microns.

The “carding process”, as discussed herein, refers to a process for producing non-woven fibrous webs. In the carding process, a bulky batt of staple fibers is combed or treated to get a non-woven fibrous web of generally uniform basis weight. Carded non-woven fibrous webs are made by combing or carding of staple fibers. The process of combing or carding the staple fibers breaks and aligns the staple fibers in machine direction.

The “wetlaying process”, as discussed herein, refers to a process for making wetlaid non-woven fibrous webs by depositing aqueous slurry of fibers on a collecting surface. The wetlaid non-woven fibrous web is further dewatered and consolidated by pressing by rollers and drying.

The “airlaying process”, as discussed herein, refers to a process for making airlaid non-woven fibrous webs. In the airlaying process, fiber bundles are introduced in a stream of air to separate the fibers. The separated fibers are deposited onto a collecting surface to form an airlaid non-woven fibrous web.

The “hydroentangling process”, as discussed herein, refers to a process for making non-woven fibrous webs. In the hydroentangling process, high speed water jets are directed against loose fiber webs to obtain a uniform sheet or fabric. The high speed water jets displace and rotate the loose fibers with respect to their neighboring fibers to twist or interlock the fibers. The hydroentangling process results in a compressed and uniform sheet of entangled fibers. Hydroentangled non-woven fibrous webs are also known as spunlaced non-woven fibrous webs.

The collecting surface discussed in the above mentioned fiber laying processes can be a moving belt or a screen. Further, the collecting surface can be porous to allow air or water to pass through it. After the fiber laying process, the non-woven fibrous webs are bonded using various bonding techniques. The bonding techniques, including but are not limited to, thermal bonding, through-air bonding, needling, point bonding, ultrasonic bonding, liquid or chemical adhesive bonding, hydroentagling and combinations thereof. Two or more layers of the non-woven fibrous webs can also be joined together using the above-mentioned bonding techniques.

In an embodiment, a multilayered laminate of non-woven fibrous webs can be formed. In the multilayered laminate a meltblown non-woven fibrous web is sandwiched between two layers of a spunbond non-woven fibrous web. This multilayer laminate of non-woven fibrous webs is known as spunbond-meltblown-spunbond (SMS) non-woven fibrous web.

The “thermal bonding” process, as described herein, is a process of bonding fibers in a non-woven fibrous web by heating the non-woven fibrous web to consolidate the non-woven fibrous web. The non-woven fibrous web can also be heated under pressure to consolidate the non-woven fibrous web.

The “through-air bonding” or “TAB” process, as described herein, is a process of bonding fibers in a non-woven fibrous web by passing hot air through the non-woven fibrous web. The hot air melts a binder material present in the non-woven fibrous web. On cooling the non-woven fibrous web, the fibers in the non-woven fibrous web bond at points where the binder material was present in the molten state.

The “needle bonding” process, as described herein, is a process of bonding fibers in a non-woven fibrous web. The needle bonding process involves mechanically consolidating the non-woven fibrous webs by inserting barbed needles into the non-woven fibrous web. The barbed needles are twisted to entangle the fibers in needle punched areas of the non-woven fibrous web.

The “point bonding” process, as discussed herein, is a process for thermally bonding fibers in a non-woven fibrous web. The point bonding process uses a two-roll nip consisting of a heated and patterned first roll and a smooth or patterned second roll. The second roll can be optionally heated. As the non-woven fibrous web is introduced between the first and the second roll, fiber temperature at the point of contact rises to a level at which tackiness and melting of the fibers causes bonding in the non-woven fibrous web.

The “ultrasonic bonding” process, as discussed herein, is a process for bonding fibers in a non-woven fibrous web by application of an alternating ultrasonic compressive force to the non-woven fibrous webs. The ultrasonic compressive force converts to thermal energy that leads to softening of fibers. Bonding of the non-woven fibrous web occurs at points where softened fibers press against each.

Bonding of fibers in non-woven fibrous webs can also be created by a “chemical bonding” process. The chemical bonding process involves using a binder such as a liquid emulsion binder, a latex binder, a liquid or chemical adhesive, a chemical bonding agent, and mixtures thereof. The binder applied to one or more surfaces of the non-woven fibrous web partially impregnates the non-woven fibrous web. Bonding of the fibers in the non-woven fibrous web impregnated with the binder is achieved by heating the non-woven fibrous web. Bonding achieved using the liquid adhesive binders is also known as liquid adhesive bonding.

The binder can be made using a latex adhesive commercially available as Rovene 5550™ (49 percent solids styrene butadiene) available from Mallard Creek Polymers of Charlotte, N.C. Other suitable binders are available from National Starch and Chemical, including DUR-O-SET 25-149A™ (T_{g}=+90° C.), NACRYLIC 25-012A™ (T_{g}=−340° C.), NACRYLIC 25-4401™ (T_{g}=−230° C.), NACRYLIC ABX-30-25331A™, RESYN 1072™ (T_{g}=+370° C.), RESYN 1601™, X-LINK 25-033A™, DUR-O-SET C310™, DUR-O-SET ELITE ULTRA™ (vinylacetate hompolymers and copolymers), STRUCTURECOTE 1887™ (modified starch), NATIONAL 77-1864™ (T_{g}=+1000° C.) (modified starch), TYLAC NW-4036-51-9™ (styrene-butadiene terpolymer), and from Air Products Polymers, including Flexbond AN214™ (T_{g}=+300° C.)(vinylacetate copolymer). The binder may be applied to the non-woven fibrous web by any suitable means such as spraying, brushing, flooding, rolling, and the like. The amount of binder applied and the degree of penetration of the binder are controlled so as to avoid impairing the effective absorbency of the non-woven fibrous web.

Various tests can be performed in order to test the strength and durability of the non-woven fibrous webs. The tests include tests for tensile strength. A tensile load at which the non-woven fibrous web breaks is known as a breaking load.

In an embodiment of the present invention, the non-woven web comprises at least one layer of a non-woven material comprising bi-component fibers and feathers. In one embodiment of the invention, the bi-component fibers and feathers in the non-woven material are evenly distributed. The bi-component fibers constitute 40% to 99% by weight of the non-woven material, and preferably about 40% to 70% by weight of the non-woven material. The feathers constitute 1% to 60% by weight of the non-woven material, and more preferably about 30% to 60% by weight of the non-woven material. Further, the non-woven web has a breaking load greater than 0.9 lbf, and more preferably greater than 1.0 lbf, when in dry state. One or both components of the bi-component fibers can have a melting point less than 200° C. The basis weight of the non-woven web can range from 25 gsm to 110 gsm, more preferably from about 30 gsm to 90 gsm. The non-woven web can be made using any of the above-described fiber laying processes and any suitable bonding techniques. In one embodiment of the invention, the bi-component fibers constituting the non-woven material comprise staple fibers. In another embodiment, the different layers of the non-woven material, wherein one or more layers comprises, bi-component fibers and feathers and are bonded by any of the above-mentioned bonding techniques.

In yet another embodiment of the present invention, the non-woven web comprises at least one layer of a non-woven material made using an airlaying process. In the tensile strength test of the non-woven web of the present embodiment the elongation of the non-woven web in machine direction at breaking load is less than 15%, and more preferably less than 10%, when in dry state. In one embodiment, the basis weight of the non-woven web ranges from about 30 gsm to 80 gsm. In another embodiment, the two components of the bi-component fibers have different melting points. In a further embodiment, the web comprises different layers of the non-woven material, wherein at least one layer is made using the airlaying process, and the various layers are bonded by any of the above mentioned bonding techniques.

In another embodiment of the present invention, the non-woven web comprises at least one layer of an airlaid non-woven material comprising thermoplastic fibers and feathers. The thermoplastic fiber comprises a bi-component fiber. In another embodiment, one or both components of the thermoplastic fibers have a melting point less than 200° C. The basis weight of the non-woven web can range from 30 gsm to 80 gsm. The non-woven web may be bonded by any of the above-described bonding techniques. The thermoplastic fibers in the non-woven material comprise staple fibers. In an embodiment, different layers of the airlaid non-woven material are bonded by any of the above-mentioned bonding techniques.

In another embodiment of the present invention, the non-woven web comprises at least one layer of a non-woven material made using an airlaying process. A combination of feathers and thermoplastic fibers is fed to a fiber separator. The fiber separator separates coarse lumps of feathers and thermoplastic fibers into individualized feathers and thermoplastic fibers. The feathers and the thermoplastic fibers resulting from the fiber separator are then deposited on a first sheet using the airlaying process. The deposited feathers and thermoplastic fibers are covered by a second layer which may be an insulating material or block which presses down on the non-woven material as it is heated so that the feathers and fibers adhere to one another. Similarly, the fibers and feathers may be bonded to another layer of material to form a laminate. The laminate is then treated using any of the above-described bonding techniques to get a bonded non-woven web. In an embodiment, different layers of the non-woven material made using the airlaying process are bonded by any of the above-mentioned bonding techniques.

In an embodiment of the invention, lumps in the combination of feathers and thermoplastic fibers can be smoothed out manually or mechanically or any other suitable mechanism to create a more uniform non-woven web.

In another embodiment of the invention, the first and the second sheets are removed after the laminate is treated to get the bonded non-woven web.

In an embodiment of the invention, the laminate is heated at about 150° C. to 300 for 5 to 20 minutes to create the bonded non-woven web.

The invention can be used as a replacement for hi-loft, low basis weight, strong, and abrasives materials in cleaning articles.

### EXAMPLE 1

This example describes a process for preparation of a non-woven web from thermoplastic fibers and feathers:

A square sheet of dimension 17.75 inches is used for depositing a combination of feathers and thermoplastic fibers. Approximately 20.3 grams of the combination of feathers and thermoplastic fibers are deposited on the square sheet to create a basis weight of 100 gsm of the non-woven web. Lumps in the combination of feathers and thermoplastic fibers are broken up or smoothed out manually by rolling the lumps of feathers and thermoplastic fibers between the fingers. The combination of feathers and thermoplastic fibers is then fed into a machine for airlaying onto a first sheet. The first sheet is placed on a screen. The thermoplastic fibers and feathers are deposited on the first sheet. Deposited feathers and thermoplastic fibers are then covered with a second sheet. The screen is taken out. The first sheet is covered with an insulating material and the second sheet is covered with a second insulating material. The first and second insulating materials may be any material that transfers heat to the non-woven material to promote adhesion of the fibers and feathers but does not adhere to the non-woven web. Suitable insulating materials include but are not limited to, paper materials, cardboard, metal sheet or blocks and the like. A metal bake-sheet is placed on top of the second insulating material and a metal weight is put on the first insulating material to form a laminated system ready for bonding treatment. The bonding treatment includes heating the laminated system at 200° C. for 10 minutes.

### EXAMPLE 2

This example describes a process for preparation of a non-woven web from thermoplastic fibers and feathers:

A square sheet of dimension 17.75 inches is used for depositing a combination of feathers and thermoplastic fibers. Approximately 6.09 grams of the combination of feathers and thermoplastic fibers are deposited on the square sheet for a basis weight of 30 gsm of the non-woven web. Lumps in the combination of feathers and thermoplastic fibers are broken up or smoothed out manually by rolling the lumps of feathers and thermoplastic fibers between the fingers. The combination of feathers and thermoplastic fibers is then fed into a machine for airlaying onto a first sheet. The first sheet is placed on a screen. The thermoplastic fibers and feathers are deposited on the first sheet. Deposited feathers and thermoplastic fibers are then covered with a second sheet. The screen is taken out. The first sheet is covered with a first insulating material and the second sheet is covered with a second insulating material. A metal bake-sheet is placed on top of the second cardboard and a metal weight is put on the first cardboard to form a laminated system ready for bonding treatment. The bonding treatment includes heating the laminated system at 200° C. for 12 minutes.

### EXAMPLE 3

This example describes test results of a tensile strength test conducted on a non woven web with a basis weight of 79 gsm. The tensile strength test is based on ASTM D 5035-95 standard. The tensile strength test was conducted in machine direction on two test specimens of the non-woven web in dry condition. The two test specimens were manufactured using 50% by weight bi-component fibers and 50% by weight of chicken feathers. The two test specimens were treated using through-air-bonding technique and heating. Table 1 shows load on the two test specimens with increasing extension during the tensile strength test. Table 2 shows the mean results of the tensile strength test conducted on the two test specimens.

TABLE 1

| | |
|---|---|
| Test Specimen 1 | Test Specimen 2 |

| | Extension | | Extension | |
|---|---|---|---|---|
| Serial No. | (inches) | Load (lbf) | (inches) | Load (lbf) |
| 1 | 0 | 0 | 0 | 0 |
| 2 | 0.1 | 0.27 | 0.1 | 0.30 |
| 3 | 0.2 | 0.70 | 0.2 | 0.77 |
| 4 | 0.3 | 1.07 | 0.3 | 1.05 |
| 5 | 0.36 | 1.19 | 0.38 | 1.12 |
| 6 | 0.4 | 1.19 | 0.4 | 1.10 |
| 7 | 0.5 | 0.83 | 0.5 | 0.70 |
| 8 | 0.6 | 0.15 | 0.6 | 0.25 |

TABLE 2

| | Extension | % | % | | Energy at |
|---|---|---|---|---|---|
| Maxi- | at | Elongation | Elongation | Energy at | maximum |
| mum | maximum | at maximum | at maximum | maximum | tensile |
| Load | load | load | extension | load | extension |
| (lbf) | (inches) | (%) | (%) | (feet-lbf) | (feet-lbf) |
| 1.12521 | 0.35998 | 11.99941 | 22.07988 | 0.01867 | 0.03468 |

### EXAMPLE 4

This example describes a process for the preparation of a non-woven web from bi-component fibers and wood pulp, and testing of the non-woven web:

A bi-component fiber used herein consists of Polyethylene Terephthlate (PET) and Polyethylene (PE). A square sheet of dimension 17.75 inches is used for depositing a combination of wood pulp and the bi-component fibers. Approximately 20.33 grams of the combination of the wood pulp and the bi-component fibers were deposited to create a non-woven web with a basis weight of 100 gsm of the non-woven web. The combination of the wood pulp and the bi-component fibers consists of 50% by weight of the wood pulp and 50% by weight of the bi-component fibers. About 10.17 grams of the wood pulp and about 10.17 grams of the bi-component fibers are used to form the combination of the wood pulp and the bi-component fibers. A first and a second set of test specimens are prepared for the purpose of tensile strength test. For the first set of test specimens, about 10.2 grams of the wood pulp and about 10.2 grams of the bi-component fibers are used to form the combination of the wood pulp and the bi-component fibers. The first set of test specimen consists of six test specimens. For the second set of test specimens, about 10.1 grams of the wood pulp and about 10.1 grams of the bi-component fibers are used to form the combination of the wood pulp and the bi-component fibers. The second set of test specimen consists of three test specimens. Lumps in the combination of the wood pulp and the bi-component fibers were smoothed out manually by rolling them between the fingers.

The combination of the wood pulp and the bi-component fibers is then fed into a machine for airlaying onto a first sheet. Pressure in the machine for airlaying is adjusted to about 30 psi. The first sheet was placed on a screen. The bi-component fibers and the wood pulp are deposited on the first sheet. Deposited wood pulp and bi-component fibers are then covered with a second sheet. The screen is taken out. The first sheet is covered with a first cardboard and the second sheet is covered with a second cardboard. A metal bake-sheet is placed on top of the second cardboard and a metal weight is put on the first cardboard to form a laminated system ready for bonding treatment. The bonding treatment includes heating the laminated system at about 200° C. for 30 minutes. The tensile strength test is conducted on the first and the second set of test specimens. The tensile strength test is based on ASTM D 5035-95 standard. The first and the second set of test specimens of the non-woven webs were in dry condition and the tensile strength test was conducted in machine direction. Table 3 and 4 show dimensional and weight specifications of the first and the second set of test specimens respectively. Table 5 and 6 show results of the tensile strength test conducted on the first and the second set of test specimens respectively.

TABLE 3

| | Thickness | Mass when dry |
|---|---|---|
| Specimen No. | (inches) | (grams) |
| 1 | 0.08 | 0.587 |
| 2 | 0.085 | 0.687 |
| 3 | 0.073 | 0.623 |
| 4 | 0.043 | 0.425 |
| 5 | 0.080 | 0.458 |
| 6 | 0.065 | 0.490 |

TABLE 4

| Specimen | Thickness | Mass when dry | Mass when wet |
|---|---|---|---|
| No. | (inches) | (grams) | (grams) |
| 1 | 0.091 | 0.733 | 4.705 |
| 2 | 0.065 | 0.491 | 5.188 |
| 3 | 0.076 | 0.440 | 5.157 |

TABLE 5

| | Extension at | Maximum | Energy at maximum |
|---|---|---|---|
| | maximum load | load | tensile extension |
| Specimen No. | (inches) | (lbf) | (ft-lbf) |
| 1 | 0.11259 | 1.84939 | 0.01272 |
| 2 | 0.07899 | 1.90902 | 0.01614 |
| 3 | 0.11178 | 2.29213 | 0.02320 |
| 4 | 0.08640 | 2.91904 | 0.01885 |
| 5 | 0.10399 | 1.34935 | 0.01005 |
| 6 | 0.18360 | 3.43341 | 0.04436 |
| Mean | 0.11289 | 2.29206 | 0.02089 |
| Standard deviation | 0.03723 | 0.76513 | 0.01239 |
| Maximum | 0.18360 | 3.43341 | 0.04436 |
| Minimum | 0.07899 | 1.34935 | 0.01005 |

TABLE 6

| | Extension at | Maximum | Energy at maximum |
|---|---|---|---|
| | maximum load | load | tensile extension |
| Specimen No. | (inches) | (lbf) | (ft-lbf) |
| 1 | 0.11159 | 1.44344 | 0.01388 |
| 2 | 0.18159 | 2.47733 | 0.04641 |
| 3 | 0.14920 | 1.54319 | 0.01924 |
| Mean | 0.14746 | 1.82132 | 0.02651 |
| Standard deviation | 0.03504 | 0.57031 | 0.01744 |
| Maximum | 0.18159 | 2.47733 | 0.04641 |
| Minimum | 0.11159 | 1.44344 | 0.01388 |

The foregoing description of illustrated embodiments of the present invention, including what is described in the abstract, is not intended to be exhaustive or to limit the invention to the precise forms disclosed herein. While specific embodiments and examples of the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention. There are a wide variety of applications for cleaning tools comprising feathers in a non-woven web, including but not limited to, mops, scrub brushes, sponges, pads, wipes, toilet cleaning devices, bath and shower cleaning tools and the like.

The foregoing description of illustrated embodiments of the present invention, including what is described in the abstract, is not intended to be exhaustive or to limit the invention to the precise forms disclosed herein. While specific embodiments and examples of the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without the corresponding use of other features, without departing from the scope and spirit of the invention as set forth. Therefore, many modifications may be made to adapt a particular situation or material to the essential scope and spirit of the present invention. It is intended that the invention not be limited to the particular terms used in the following claims and/or to the particular embodiment disclosed as the best mode contemplated for carrying out this invention, but that the invention includes any and all embodiments and equivalents falling within the scope of the appended claims.

While various patents have been incorporated herein by reference in the background, to the extent there is any inconsistency between incorporated material and that of the written specification, the written specification shall control. In addition, while the invention has been described in detail with respect to specific embodiments thereof, it will be apparent to those skilled in the art that various alterations, modifications and other changes may be made to the invention without departing from the spirit and scope of the present invention. It is therefore intended that the claims cover all such modifications, alterations and other changes encompassed by the appended claims.

What is claimed is:

1) A non-woven web comprising at least one layer of non-woven material, the non-woven material comprising a substantially even distribution of thermoplastic fibers and feathers, wherein:
i. the thermoplastic fibers constitute 10-99% by weight of the non-woven material,
ii. the feathers constitute 1-90% by weight of the non-woven material; and
iii. the non-woven web has a mean breaking load greater than 0.9 lbf in dry condition.

2) The non-woven web of claim 1, wherein the non-woven material is at least one of spunbond, meltblown, spunbond-meltblown-spunbond (SMS), carded, wetlaid, airlaid, thermalbonded, hydroentangled, through-air bonded, needled, and chemical bonded.

3) The non-woven web of claim 1, wherein at least one component of the thermoplastic fibers is selected from the group consisting of polyprolylene, polyethylene, polyethylvinyl acetate, polyester, copolyester, polyethylene terephthalate (PET), and combinations thereof.

4) The non-woven web of claim 1, wherein the thermoplastic fibers are bi-component fibers wherein at least one component of the bi-component fibers has a melting point less than 200° C.

5) The non-woven web of claim 1, wherein the non-woven web has a basis weight ranging from 25 to 110 gram per square meter.

6) The non-woven web of claim 1, wherein the non-woven web has a basis weight ranging from 30 to 80 gram per square meter.

7) The non-woven web of claim 1, wherein the layers of non-woven material are bonded together using at least one of thermal bonding, through-air-bonding (TAB), needling, liquid or chemical adhesive, point bonding, hydroentangling, and ultrasonic bonding.

8) The non-woven web of claim 1, wherein the thermoplastic fibers are staple fibers.

9) A non-woven web comprising at least one layer of an airlaid non-woven material, wherein the airlaid non-woven material comprises thermoplastic fibers and feathers.

10) The non-woven web of claim 9, wherein the thermoplastic fibers comprise materials selected from the group consisting of polyprolylene, polyethylene, polyethylvinyl acetate, polyester, copolyester, polyethylene terephthalate (PET), and combinations thereof.

11) The non-woven web of claim 9, wherein at least one component of the thermoplastic fibers has a melting point less than 200° C.

12) The non-woven web of claim 9, wherein the non-woven web has a basis weight ranging from 30 to 80 grams per square meter.

13) The non-woven web of claim 9, wherein the layers of non-woven material are bonded together using at least one of thermal bonding, through-air-bonding (TAB), needling, liquid or chemical adhesive, point bonding, hydroentagling and ultrasonic bonding.

14) The non-woven web of claim 9, wherein the thermoplastic fibers are staple fibers.

15) A non-woven web comprising at least one layer of an airlaid non-woven material comprising thermoplastic fibers and feathers, wherein:
i. at least one component of the thermoplastic fibers is selected from the group consisting of polyprolylene, polyethylene, polyethylvinyl acetate, polyester, copolyester, polyethylene terephthalate (PET), and combinations thereof,
ii. the thermoplastic fibers constitute 10-99% by weight of the non-woven material,
iii. the feathers constitute 1-60% by weight of the non-woven material; and
iv. percent elongation of the non-woven web in dry condition in machine direction at breaking load is less than 15%.

16) The non-woven web of claim 15, wherein at least one component of the thermoplastic fibers has a melting point less than 200° C.

17) The non-woven web of claim 15, wherein the non-woven web has a basis weight ranging from 30 to 80 grams per square meter.

18) The non-woven web of claim 15, wherein the layers of non-woven material are bonded together using at least one of thermal bonding, through-air-bonding (TAB), needling, liquid or chemical adhesive, point bonding, hydroentangling and ultrasonic bonding.

19) The non-woven web of claim 15, wherein the thermoplastic fibers are staple fibers.

20) A non-woven web of claim 15, wherein the thermoplastic fibers are bi-component fibers comprising at least two materials with different melting points.
